(19) United States
(12) Patent Application Publication
(10) Pub. No.: US 2012/0281748 A1
(43) Pub. Date: Nov. 8, 2012

(54) Rate Control for Cloud Transcoding

(75) Inventors: Zhang Peng, Shenzhen (CN); Zhenyu Wu, Shenzhen (CN); Lou Shuai, Shenzhen (CN)

(73) Assignee: FUTUREWEI TECHNOLOGIES, INC., Plano, TX (US)

(21) Appl. No.: 13/462,435

(22) Filed: May 2, 2012

Related U.S. Application Data
(60) Provisional application No. 61/481,583, filed on May 2, 2011.

(51) Int. Cl. H04N 7/26

(52) U.S. Cl. 375/240.01; 375/E07.026

(57) ABSTRACT

A method implemented by an apparatus for video transcoding comprising receiving video data intended for encoding, splitting the video data into a plurality of segments of appropriate sizes to enable distributed encoding by a plurality of video transcoders, obtaining rate control information for each of the segments by calculating related video statistics for each of the segments with subsequent segments in a determined time period, calculating an assigned bit rate to each of the segments based on the obtained rate control information, embedding the assigned bit rate to each of the segments, and forwarding the segments to a plurality of corresponding video transcoders, wherein the embedded assigned bit rate in each of the segments is extracted by the corresponding video transcoders to perform video rate control and enables the video transcoders to improve video quality and reduce rate fluctuation when encoding the segments.

### CROSS-REFERENCE TO RELATED APPLICATIONS

The present application claims the benefit of U.S. Provisional Patent Application No. 61/481,583 filed May 2, 2011 by Zhang Peng et al. and entitled “Rate Control for Cloud Transcoding,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Current video provider systems deliver video content to subscribers or users using coding and decoding schemes for different user devices, such as televisions, notebook computers, and mobile devices. The video provider systems comprise video transcoders that convert a video content from a source or original format to different formats, which can be supported by the different user devices. Cloud based video transcoding is a high performance and low cost video processing solution, where a plurality of virtual video transcoders distributed in one or more networks (e.g., the Internet) are used to process or encode video collectively. The term cloud may refer to any logical group of components or devices in one or more networks or communication/computation systems that perform a task collectively, such as a distributed processing system. Cloud based video transcoding has several advantages, such as the number of video transcoders is scalable and the system is fault tolerant. Cloud based video transcoding may also achieve improved system utilization by reducing the granularity of task, e.g., by distributing and processing video segments of proper sizes at different video transcoders. Cloud based video transcoding also has disadvantages, such as the video transcoders in the cloud may not communicate with each other and video quality or bit rate may be difficult to control.

### SUMMARY

In an embodiment, the disclosure includes a method implemented by an apparatus for video transcoding comprising receiving video data intended for encoding, splitting the video data into a plurality of segments of appropriate sizes to enable distributed encoding by a plurality of video transcoders, obtaining rate control information for each of the segments by calculating related video statistics for each of the segments with subsequent segments in a determined time period, calculating an assigned bit rate to each of the segments based on the obtained rate control information, embedding the assigned bit rate to each of the segments, and forwarding the segments to a plurality of corresponding video transcoders, wherein the embedded assigned bit rate in each of the segments is extracted by the corresponding video transcoders to perform video rate control and enables the video transcoders to improve video quality and reduce rate fluctuation when encoding the segments.

In another embodiment, the disclosure includes a method implemented by an apparatus for video transcoding comprising receiving from a video splitter one or more assigned segments that belong to a set of segments for a video file, extracting global rate control bit allocation embedded in the assigned segments, using the extracted global rate control bit allocation for performing rate control during encoding of the assigned segments to reduce rate fluctuation in the set of segments that are encoded by a plurality of video transcoders, and forwarding the encoded assigned segments to a video combiner that merges the set of segments from the video transcoders into a final video file.

In yet another embodiment, the disclosure includes a video transcoding system comprising a video splitter that receives input video data for encoding, obtains rate control information based on analysis of the input video data, splits the input video data into a plurality of segments, calculates global rate control bit allocation for the segments using the rate control information, embeds the global rate control bit allocation into the segments, and forwards the segments for encoding, and a plurality of video transcoders coupled to the video splitter that receive the segments as assigned to the video transcoders, extract the embedded global rate control bit allocation from the assigned segments, and encode the segments at a plurality of bit rates based on the extracted rate control information.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a cloud based video transcoding system.

FIG. 2 is a schematic diagram of another embodiment of a cloud based video transcoding system.

FIG. 3 is a flowchart of an embodiment of a video splitting method.

FIG. 4 is a flowchart of an embodiment of a video transcoding method.

FIG. 5 is a schematic diagram of an embodiment of a network unit.

FIG. 6 is a schematic diagram of an embodiment of a general-purpose computer system.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Video rate control may be challenging in cloud based transcoding systems since the input video intended for transcoding may be split into a plurality of segments that are processed (encoded) separately or independently by different transcoders. This may cause, relatively large video rate fluctuation in the processed video segments, and thus prevent good and constant video quality. Hence, there may be a need for improved video bit rate control in cloud based video transcoding systems.

Disclosed herein is a system and method to enable global rate control for cloud based video transcoding. The disclosed cloud based video transcoding system may comprise a storage cloud, a transcoding cloud, and a video splitter and a video combiner positioned between the storage cloud and the transcoding cloud. After a transcoding request is submitted, the video splitter may retrieve an input video file from the storage cloud, split the file into a plurality of video segments, and feed the segments into the transcoding cloud. Additionally, to achieve global video rate control, the video splitter may be equipped with video analysis and global rate control preprocessing functionalities. Using such functionalities, the video splitter may generate and embed global rate control bit allocation into each segment before forwarding the segment to the transcoding cloud. In the transcoding cloud, the segments may be assigned to different video transcoders (e.g., virtual video transcoders) for processing. During the transcoding process, each video transcoder may extract the embedded global rate control bit allocation in the assigned segment(s) and allocate bit rate based on the extracted information in the segment(s). The video transcoders may then output the processed segments to the video combiner. The video combiner may assemble the segments from the different video transcoders, reorder the segments, and encapsulated the reordered segments into a proper video format.

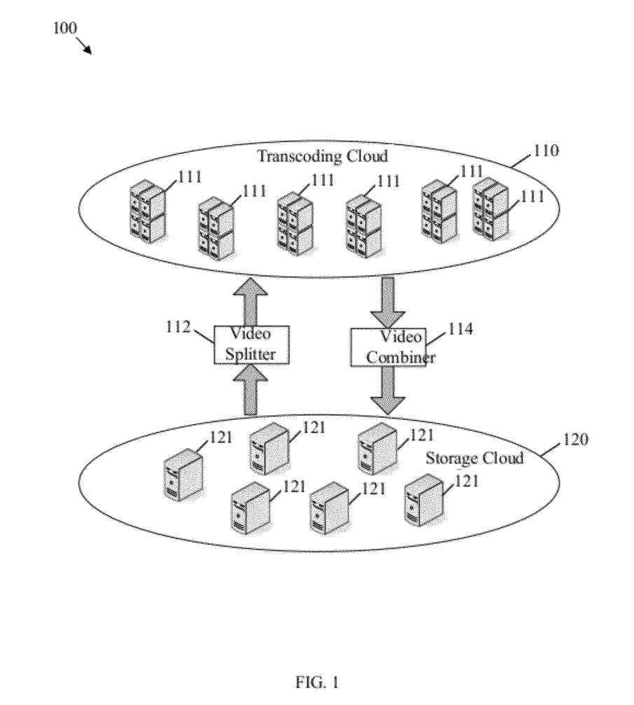

FIG. 1 illustrates an embodiment of a cloud based video transcoding system 100, which may implement global video rate control among multiple transcoders in the cloud, e.g., to reduce video rate fluctuation and achieve improved constant video quality. The cloud based video transcoding system 100 may comprise a transcoding cloud 110 that comprises or is coupled to a plurality of video transcoders 111 and a storage cloud 120 that comprises or is coupled to one or more video storages 121. The cloud based video transcoding system 100 may also comprise a video splitter 112 and a video combiner 114, which may be both coupled to the transcoding cloud 110 and the storage cloud 120. The components of the cloud based video transcoding system 100 may be arranged as shown in FIG. 1.

The transcoding cloud 110 may correspond to at least one network (e.g., the Internet) that comprises or is coupled to a plurality of video transcoders 111. The video transcoder 111 may be any processing component configured to convert digital-to-digital data of one video encoding to another, such as for movie files or audio files. For example, video transcoding may be implemented where a target device (or workflow) does not support a video file format or has limited storage capacity that mandates a reduced file size. Video transcoding may also be implemented to convert incompatible or obsolete video data to a better-supported or modern format. Transcoding may be performed while video files are being searched such in background processing (e.g., overnight), or for streaming real-time or upon demand video. A common operation in this application is the transcoding of Moving Picture Experts Group (MPEG)-2 files to the MPEG-4 or H.264 (or Advanced Video Coding (AVC)) video formats.

The video transcoders 111 may be implemented using hardware and/or software on one or more devices, such as general purpose computers, network or data center servers, network interface cards (NICs), and/or other suitable devices. The devices may also include devices at customer residences (e.g., set top box and digital video recorders (DVRs)) and portable/personal communications devices (e.g., smart phones and laptop/tablet computers). A video transcoder 111 may be a coder-decoder (CODEC) implemented using a device and/or a computer program capable of encoding or decoding a digital data stream or signal. For example, transcoding may be used by personal computer (PC) software to reduce the usage of disk space by video files.

The storage cloud 120 may correspond to one or more networks that comprise a plurality of video storages 121, which may or may not be connected or in communications with one another. For instance, the storage cloud 120 may correspond to the Internet and/or any other network(s) that comprise or are coupled to the video storages 121. The video storages 121 may be any storage component or device configured to maintain digital data. For example, the video storages 121 may include one or more hard disks, temporary memory devices (e.g., random access memory (RAM) devices), portable memory devices (e.g., universal serial bus (USB) memory device or memory cards), and/or other digital data storage technologies. The video storage(s) 121 may be located at a single server (e.g., a physical box) or may be distributed, e.g., in a data center, a network, at customer residences, at portable/personal communications devices, or combinations thereof The video storages 121 may store and maintain video file formats before and/or after transcoding.

The video splitter 112 may be any processing component implemented by hardware and/or software and configured to receive video (e.g., a video file/compression format), split the video into a plurality of segments (or chunks), and forward the segments to the transcoding cloud 110, where the segments may be received and processed or encoded by different video transcoders 111. The segments may be the smallest input task units for video processing, and may vary in size depending on the file/compression format of the video. The video combiner 114 may be any processing component implemented by hardware and/or software and configured to receive the processed segments from the different video transcoders 111 in the transcoding cloud 110, reorder the segments appropriately, combine the reordered segments into a final video format or file format, and forward the final video file/format to the storage cloud 120. The video file may then be stored at one or more video storages 121 in the storage cloud 120.

If the different video transcoders 111 perform rate control locally or independently for their assigned segments, e.g., with no rate information exchange between the different video transcoders 111, the resulting processed segments and hence resulting video files may have substantial differences (fluctuation) in bit rates. This may result in relatively poor and variable video quality. To achieve more favorable and constant video quality, global rate control in the transcoding cloud 110 may be needed. In global rate control, the different video transcoders 111 may use calculated global rate control bit allocation per segment to control the rates for their corresponding segments, which may enable more predictable, suitable, and/or comparable rates in the outputs of the video transcoders 111 and hence the video combiner 114.

Specifically, the video splitter 112 may be configured to calculate and embed global rate control bit allocation for each of the segments, as described below, before forwarding the segments to the video transcoders 111. The video transcoders 111 may then extract and use the embedded information in the segments and perform rate control (during the transcoding process) based on the embedded information (rate control bit allocation per segment). The calculated global rate control bit allocation per segment may enable the video transcoders 111 to achieve lower rate fluctuation in the encoded segments and hence more constant video quality (e.g., at the output of the video combiner 114).

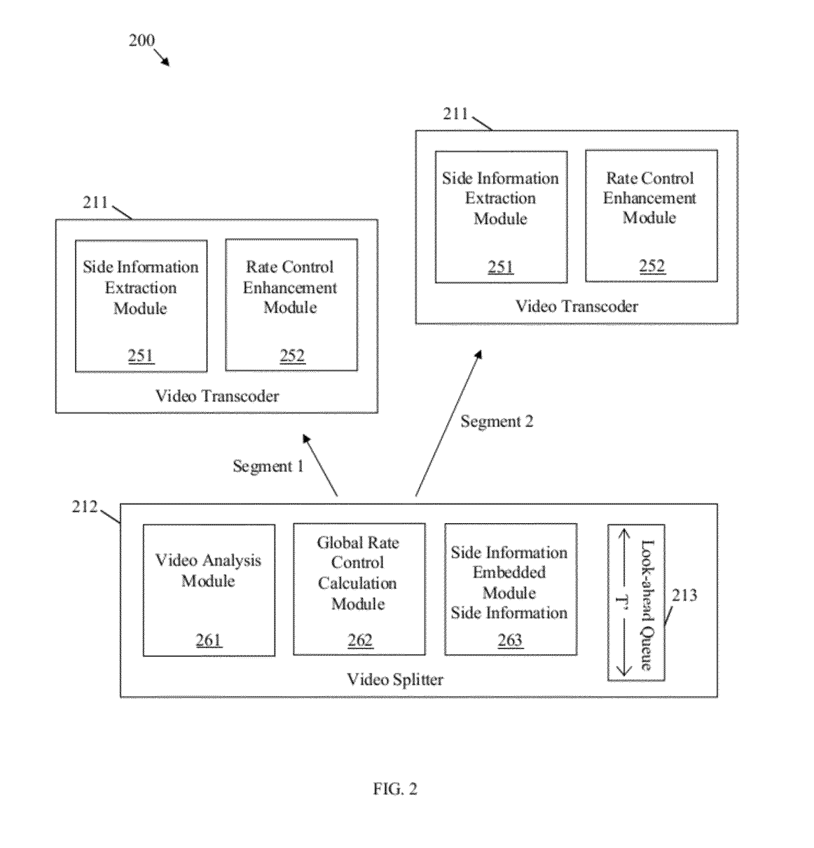

FIG. 2 illustrates another embodiment of a cloud based video transcoding system 200, which may implement the global video rate control among multiple transcoders in the cloud. The cloud based video transcoding system 200 may comprise a video splitter 212 and a plurality of video transcoders 211, which may be distributed in a cloud (e.g., the Internet and/or other network(s)) and coupled to the video splitter 212. For instance, the video splitter 212 and the video transcoders 211 may correspond to the video splitter 112 and the video transcoders 111, respectively. The video splitter 212 may comprise a video analysis module 261, a global rate control calculation module 262, a side information embedded module 263, and a look-ahead queue 213. Each video transcoder 211 may comprise a side information extraction module 251 and a rate control enhancement module 252. The components above of the video splitter 212 and the video transcoders 211 may be implemented using hardware (e.g., circuit), software (e.g., program), or both.

The video analysis module 261 may analyze the input video (e.g., from the storage cloud 120) to obtain relevant rate control information. The video analysis module 261 may parse the input video file to obtain the rate control information, e.g., when the video splitter 212 splits the input video into a plurality of segments of proper size (based on the video format). The rate control information may comprise the quantity of motion bits in the video, the quantity of texture bits and miscellaneous bits, quantization and motion information, picture type and macroblock types, weighted prediction information, other video related statistics, parameters, and information, or combinations thereof. The video analysis module 261 may also analyze a plurality of queued or buffered video in the look-ahead queue 213 to obtain additional rate control information for video data (e.g., frames, macroblocks, files, segments) subsequent to the currently parsed video data. The look-ahead queue 213 may be configured to buffer (e.g., in memory or a dedicate storage space) video data that is received in a determined window of time, T′. For example, T′ may be equal to a determined number of seconds, minutes, or hours, e.g., based on the video file compression/file format. Analyzing rate control information for video data for a time window T′ may enable video bit rate control over a corresponding extended time and hence provide more constant video quality. The extended time window T′ may be increased to further improve constant video quality or decreased to improve processing speed.

The global rate control calculation module 262 may calculate an estimated quantization parameter for each frame (and/or macroblock) in each of the segments based on the rate control information obtained by the video analysis module 261. The set of estimated quantization parameters corresponding to the frames of each segment may be used as guideline for global rate control bit allocation for the segment, which may be used by the video transcoder 211 for video rate control. The set of estimated quantization parameters for the segments may be used by the assigned video transcoders 211 in the rate control process for their assigned segments to achieve comparable rates for their segments and hence reduce rate fluctuation across the segments, and hence in the resulting video that combines the processed segments (e.g., at the video combiner). At a first step, the global rate control calculation module 262 may calculate the complexity of each frame in a segment. For the i^{th} frame, the frame's complexity (blurred_complexity) may be calculated using the following equations:

$$\begin{matrix} blurred\_complexity = cplxr\_sum / weight\_sum \\ where & eq . ( 1 ) \\ {cplxr}_{sum} = {\sum }_{j = 0}^{i} \frac{{gaussian}_{weight ( j + i )} * ( qscale 2 bits ( j + i ) - {misc}_{bits ( j + i )} )}{{frame}_{duration ( j + i )}} + {\sum }_{j = 1}^{Lookahead Size} \frac{{gaussian}_{weight ( j + i )} * ( qscale 2 bits ( j + i ) - {misc}_{bits ( j + i )} )}{{frame}_{duration ( j + i )}} & eq . ( 2 ) \\ and & \\ weight\_sum = {\sum }_{j = 0}^{i} gaussian\_weight ( j ) . & eq . ( 3 )\end{matrix}$$

The weighting factor (gaussian_weight(j)) may depend on the distance to the i^{th} frame:

gaussian_weight(j)=weight*e^{-j*j/200} eq. (4)

In the equations above, qscale2bits is an estimated quantization parameter, misc_{bits} is a quantity of miscellaneous bits, frame_{duration} is a duration of the frame, and weight is a predicted weight of the frame.

At a second step, the global rate control calculation module 262 may calculate the expected number of bits for each frame using the following equations:

$$\begin{matrix} q ( i ) = \frac{blurred\_complexity {( i )}^{1 - qcompress}}{rate\_factor} & eq . ( 5 ) \\ {expected}_{bits} += {text}_{bits} * {( \frac{{qscale}_{1 - pass}}{q ( i )} )}^{1.1} + {mv}_{bits} * {( \frac{{qscale}_{1 - pass}}{q ( i ) } )}^{0.5} + {misc}_{bits} & eq . ( 6 )\end{matrix}$$

where rate_factor equals to 1. In the equations above, expected_{bits} is the calculated expected number of bits of the frame, text_{bits} is a quantity of texture bits, qscaleᵢ₋ₚₐₛₛ is an estimated quantization parameter, mv_{bits} is an amount of movement of bits, qcompress is a compression factor, and rate_factor is equal to one.

At a third step, the global rate control calculation module 262 may calculate the proper estimated quantization parameter, qscale. This may be achieved by implementing the following steps:
define step_mult=all_available_bits/expected_bits;
set the initial value of Rate_factor to 0;
set the step size: Step=1e4*step_mult, for each loop, step*=0.5,
Rate_factor=step;
   implement the following sub-steps:
   step 3.1: calculate a new qscale for each frame according to rate_factor;
   step 3.2: modify the qscale of related intra-prediction and bi-direction frames;
   step 3.3: get the estimated number of bits:

$$\begin{matrix}New\_qscale ( i ) = clip\_qscale ( h , pict\_type , blurred\_qscale ( i ) ) & eq . ( 7 ) \\ expected\_bits += text\_bits * {( \frac{{qscale}_{1 - pass}}{{new}_{qscale ( i )}} )}^{1.1} + mv\_bits * {( \frac{{qscale}_{1 - pass}}{{new}_{qscale ( i )}} )}^{0.5} + {misc}_{bits} & eq . ( 8 )\end{matrix}$$

step 3.4: if expected_bit>all_available_bits, then rate_factor—=step, back to step 3.1;
step 3.6: finish global rate control for a segment.

Since the qscale value for a frame may be based on the qscale value of related (e.g., adjacent) intra-prediction and/or bi-direction frames, the set of estimated quantization parameters for a plurality of frame may be determined based on related frames in the segments or the input video file. The set of estimated quantization parameters in the segments that are based on related frames in the input video are used for rate control during encoding to reduce rate fluctuation across the encoded segments by the different video transcoders.

The side information embedded module 263 may embed the information calculated by the global rate control calculation module 262 into each of the segments. The segments may :then be forwarded with the embedded information to the transcoding cloud. At the transcoding cloud, each of the video transcoders 211 may receive the assigned segment(s). The side information extraction module 251 may extract the embedded information (the set of estimated quantization parameters for the frames of each segment) from the video splitter 212. The rate control enhancement module 252 may utilize the extracted information when the video transcoder 211 is performing rate control for its assigned segment(s). Thus, the processed segments at the different video transcoders 211 may achieve global rate control based on global rate control bit allocation per segment, which may result in less fluctuation in the bit rates of the resulting encoded video.

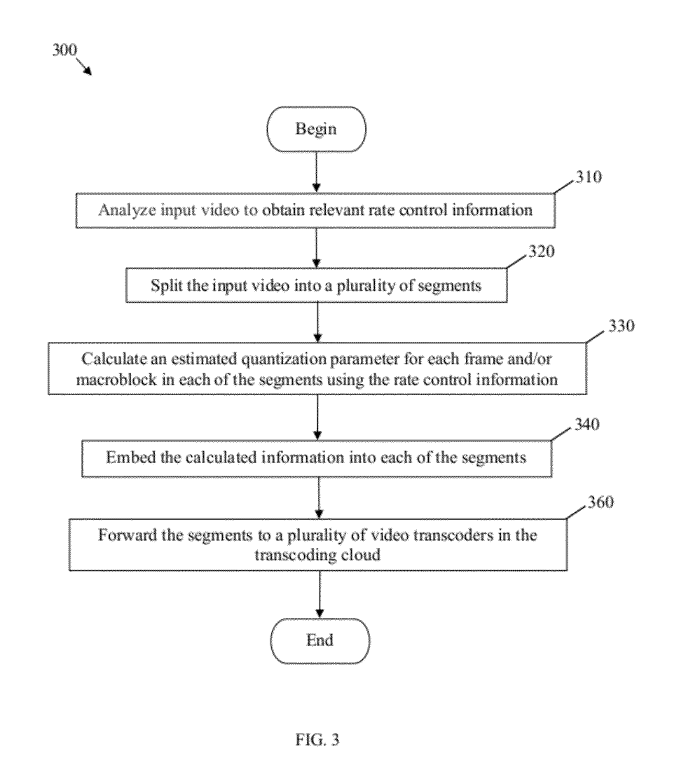

FIG. 3 illustrates an embodiment of a video splitting method 300, which may be implemented as part of the global video rate control scheme above. For instance, the video splitting method 300 may be implemented by the video splitter 112 or 212. The video splitting method 300 may begin at block 310, where input video may be analyzed to obtain relevant rate control information. For instance, the video analysis module 261 may analyze input video that is buffered in a look-ahead queue for buffering received video data. The analysis may include obtaining video information relevant to implement rate control during video encoding, such as the quantity of motion bits in the video, the quantity of texture bits and miscellaneous bits, quantization and motion information, picture type and macroblock types, and weighted prediction information. At block 320, the input video may be split into a plurality of segments. For instance, the video splitter 112 may split the input video into a plurality of segments to enable distributed processing at the transcoding cloud. At block 330, an estimated quantization parameter may be calculated for each frame and/or macroblock of each segment using the rate control information. For instance, the global rate control calculation module 262 may calculate the estimated quantization parameter for each frame in the segments using the equations above. At block 340, the calculated information may be embedded into each of the segments. For instance, the side information embedded module 263 may add to each segment the corresponding set of estimated quantization parameters and optionally other rate control information that may be relevant for rate control in the transcoding cloud. At block 350, the segments may be forwarded to a plurality of video transcoders in the transcoding cloud. The method 300 may then end.

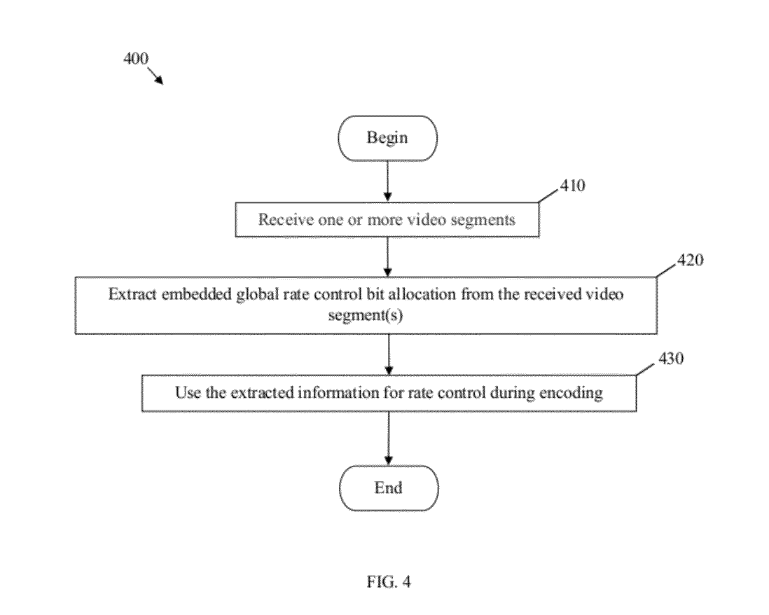

FIG. 4 illustrates an embodiment of a video transcoding method 400, which may be implemented as part of the global video rate control scheme above. For instance, the video transcoding method 400 may be implemented by the video transcoders 111 or 211. The video transcoding method 400 may begin at block 410, where one or more video segments may be received. For instance, one or more video transcoders 211 may receive a plurality of assigned segments from the video splitter 212. At block 420, embedded global rate control bit allocation may be extracted from the received video segment(s). For instance, the side information extraction module 251 may extract the set of estimated quantization parameters and optionally other relevant rate control information that may be embedded in the received segment. At block 430, the extracted information may be used for rate control during encoding. For instance, the rate control enhancement module 252 may enable the video transcoder 211 to perform rate control for processing the segment using the extracted estimated quantization parameter and other relevant rate control information. The method 400 may then end.

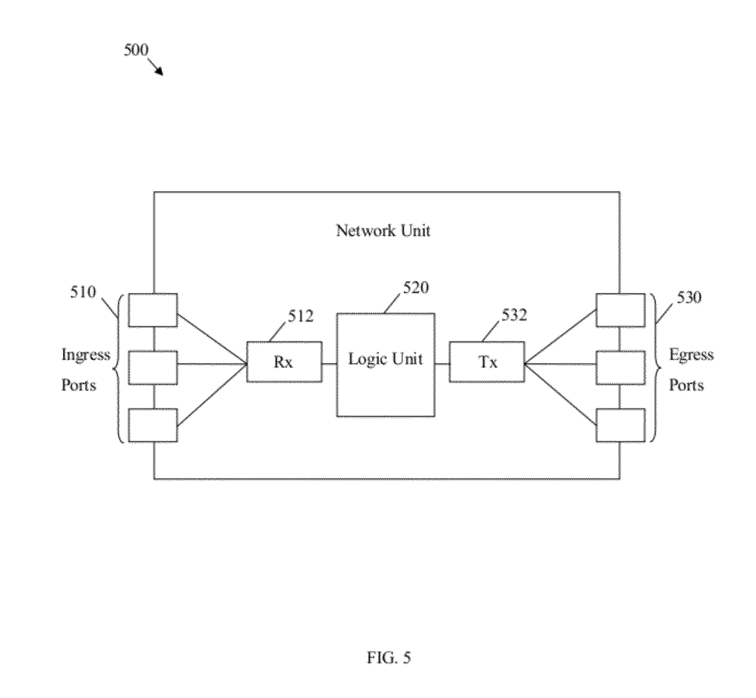

FIG. 5 illustrates an embodiment of a network unit 500, which may be any device that transports and processes data through a network, a cloud, or a video transcoding system, such as the video transcoding system 100 or 200. The network unit 500 may comprise any of the components described above, such as the video splitter 112, the video transcoder 111, the video combiner 114, and the video storage 121. The network unit 500 may comprise one or more ingress ports or units 510 coupled to a receiver (Rx) 512 for receiving signals, frames, and/or data (e.g., video files/segments) from other network units or components. The network unit 500 may comprise a logic unit 520 that support or implement the global rate control scheme above. For instance, the logic unit 520 may be a processor located at a video splitter and implements the video splitting method 300. The logic unit 520 may be a processor located at a video transcoder and implements the video transcoding method 400. The logic unit 520 may be a processor located at a video combiner and combines a plurality of received segments into a final video. The logic unit 520 may be implemented using hardware, software, or both. The network unit 500 may also comprise one or more egress ports or units 530 coupled to a transmitter (Tx) 532 for transmitting signals, frames, and/or data (e.g., video files/segments) to the other network units or components. The components of the network unit 500 may be arranged as shown in FIG. 5.

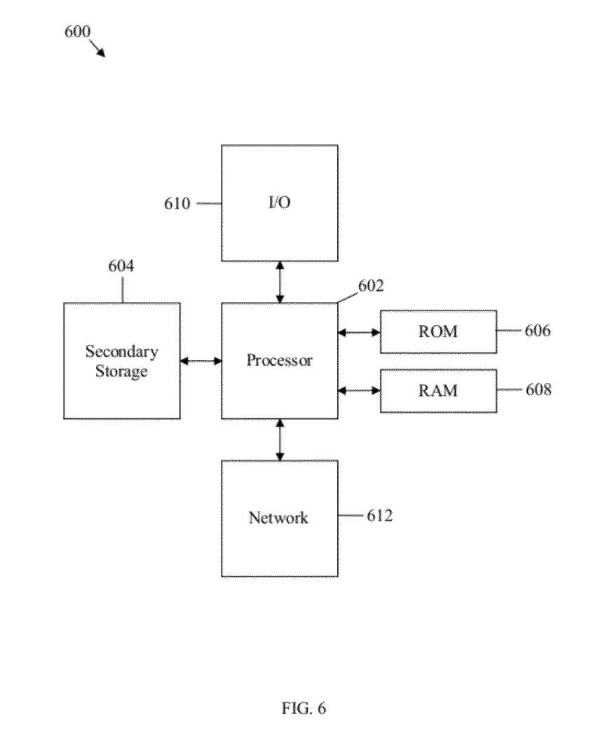

The network components and devices described above may be implemented on any general-purpose network component, such as a computer or network component with sufficient processing power, memory resources, and network throughput capability to handle the necessary workload placed upon it. FIG. 6 illustrates a typical, general-purpose network component 600 suitable for implementing one or more embodiments of the components disclosed herein. The network component 600 includes a processor 602 (which may be referred to as a central processor unit or CPU) that is in communication with memory devices including secondary storage 604, read only memory (ROM) 606, random access memory (RAM) 608, input/output (I/O) devices 610, and network connectivity devices 612. The processor 602 may be implemented as one or more CPU chips, or may be part of one or more application specific integrated circuits (ASICs).

The secondary storage 604 is typically comprised of one or more disk drives or tape drives and is used for non-volatile storage of data and as an over-flow data storage device if RAM 608 is not large enough to hold all working data. Secondary storage 604 may be used to store programs that are loaded into RAM 608 when such programs are selected for execution. The ROM 606 is used to store instructions and perhaps data that are read during program execution. ROM 606 is a non-volatile memory device that typically has a small memory capacity relative to the larger memory capacity of secondary storage 604. The RAM 608 is used to store volatile data and perhaps to store instructions. Access to both ROM 606 and RAM 608 is typically faster than to secondary storage 604.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 9 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 90 percent with a 1 percent increment, i.e., k is 1 percent, 2 percent, 3 percent, 4 percent, 8 percent, . . . , 80 percent, 81 percent, 82 percent, . . . , 97 percent, 96 percent, 97 percent, 98 percent, 99 percent, or 90 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method implemented by an apparatus for video transcoding comprising:
receiving video data intended for encoding;
splitting the video data into a plurality of segments of appropriate sizes to enable distributed encoding by a plurality of video transcoders;
obtaining rate control information for each of the segments by calculating related video statistics for each of the segments with subsequent segments in a determined time period;
calculating an assigned bit rate to each of the segments based on the obtained rate control information;
embedding the assigned bit rate to each of the segments; and
forwarding the segments to a plurality of corresponding video transcoders,
wherein the embedded assigned bit rate in each of the segments is extracted by the corresponding video transcoders to perform video rate control and enables the video transcoders to improve video quality and reduce rate fluctuation when encoding the segments.

2. The method of claim 1 further comprising:
analyzing the received video data to obtain the rate control information;
calculating an estimated quantization parameter for each frame, macroblock, or both in the segments based on the rate control information;
embedding the estimated quantization parameter for each frame, macroblock, or both into the corresponding segments before forwarding the segments.

3. The method of claim 2, wherein calculating the estimated quantization parameter for each frame comprises:
calculating a complexity of each frame in each of the segments;
calculating an expected number of bits for each frame; and
calculating a proper estimated quantization parameter for each frame.

4. The method of claim 3, wherein the complexity of each frame is calculated using the following equation:
blurred_complexity=cplxr_sum/weight_sum, where
$${cplxr}_{sum} = {\sum }_{j = 0}^{i} \frac{{gaussian}_{weight ( j + i )} * ( qscale 2 bits ( j + i ) - {misc}_{bits ( j + i )} )}{{frame}_{duration ( j + i )}} + {\sum }_{j = 1}^{Lookahead Size} \frac{{gaussian}_{weight ( j + i )} * ( qscale 2 bits ( j + i ) - {misc}_{bits ( j + i )} )}{{frame}_{duration ( j + i )}} , \\ weight\_sum + {\sum }_{j = 0}^{i} gaussian\_weight ( j ) , \\ gaussian\_weight ( j ) = weight * {e}^{- j * j / 200} ,$$
i is an index of the frame, blurred_complexity is the calculated complexity of the frame, qscale2bits is an estimated quantization parameter, misc_{bits} is a quantity of miscellaneous bits, frame_{duration} is a duration of the frame, and weight is a predicted weight of the frame.

5. The method of claim 4, wherein the expected number of bits for each frame is calculated using the equation:
$${expected}_{bits} += {text}_{bits} * {( \frac{{qscale}_{1 - pass}}{q ( i )} )}^{1.1} + {mv}_{bits} * {( \frac{{qscale}_{1 - pass}}{q ( i )} )}^{0.5} + {misc}_{bits} , \\ where q ( i ) = \frac{blurred\_complexity {( i )}^{1 - qcompress}}{rate\_factor} ,$$
expected_{bits} is the calculated expected number of bits of the frame, text_{bits} is a quantity of texture bits, qscaleᵢ₋ₚₐₛₛ is an estimated quantization parameter, mv_{bits} is an amount of movement of bits, qcompress is a compression factor, and rate_factor is equal to one.

6. The method of claim 3, wherein the proper estimated quantization parameter for each frame is calculated using a plurality of steps comprising:
calculating a new estimated quantization parameter for each frame according to a rate_factor;
modifying each estimated quantization parameter of related intra-prediction and bi-direction frames;
calculating an updated estimated number of bits based on the new estimated quantization parameter and each estimated quantization parameter of related intra-prediction and bi-direction frames; and
updating the rate_factor and returning to the calculation of a new estimated quantization parameter if the estimated number of bit is greater than a plurality of available bits.

7. The method of claim 1 further comprising:
buffering the received video data for a determined look-ahead time period; and
analyzing the buffered received video data to obtain the rate control information over the determined look-ahead time period,
wherein the rate, control information over an extended look-ahead time period enable the video transcoders to further reduce rate fluctuation when encoding the segments.

8. A method implemented by an apparatus for video transcoding comprising:
receiving from a video splitter one or more assigned segments that belong to a set of segments for a video file;
extracting global rate control bit allocation embedded in the assigned segments;
using the extracted global rate control bit allocation for performing rate control during encoding of the assigned segments to reduce rate fluctuation in the set of segments that are encoded by a plurality of video transcoders; and
forwarding the encoded assigned segments to a video combiner that merges the set of segments from the video transcoders into a final video file.

9. The method of claim 8, wherein the global rate control bit allocation includes a set of estimated quantization parameters for a plurality of frames, macroblocks, or both of the assigned segments that are determined based on related frames in the assigned segments or the set of segments.

10. The method of claim 9, wherein the set of estimated quantization parameters in the assigned segments that are based on related frames in the set of segments are used for rate control during encoding to reduce rate fluctuation across the encoded set of segments by the video transcoders.

11. The method of claim 8, wherein the assigned segments are encoded based on the extracted global rate control bit allocation independently and separately from other video transcoders that encode other corresponding assigned segments in the set of segments.

12. A video transcoding system comprising:
a video splitter that receives input video data for encoding, obtains rate control information based on analysis of the input video data, splits the input video data into a plurality of segments, calculates global rate control bit allocation for the segments using the rate control information, embeds the global rate control bit allocation into the segments, and forwards the segments for encoding; and
a plurality of video transcoders coupled to the video splitter that receive the segments as assigned to the video transcoders, extract the embedded global rate control bit allocation from the assigned segments, and encode the segments at a plurality of bit rates based on the extracted rate control information.

13. The networking system of claim 12 further comprising:
a video combiner coupled to the video transcoders that receives the encoded segments from the video transcoders and combines the segments into output video data; and
one or more video storage components coupled to the video splitter and the video combiner that store the input video data and the output video data, forward the input video data to the video splitter, and receive the output video data from the video combiner.

14. The networking system of claim 12, wherein the video splitter comprises:
a video analysis module that analyzes the input video data to obtain the rate control information;
a global rate control calculation module that calculates the global rate control bit allocation for the segments based on the rate control information; and
a side information embedded module that embeds the global rate control bit allocation for into the segments.

15. The networking system of claim 14, wherein the video splitter further comprises a look-ahead queue that buffers input video data received during a determined time window, wherein the video analysis module analyzes the buffered input video data to obtain rate control information over the determined time window.

16. The networking system of claim 15, wherein the video analysis module, global rate control calculation module, side information embedded module, side information extraction module, and rate control enhancement module are implemented using software.

17. The networking system of claim 12, wherein each of the video transcoders comprises:
a side information extraction module that extracts the embedded global rate control bit allocation from the received segments assigned to the video transcoders; and
a rate control enhancement module that utilizes the extracted global rate control bit allocation for performing rate control during encoding of the segments.

18. The networking system of claim 12, wherein the rate control information comprises a quantity of motion bits in the input video data, a quantity of texture bits and miscellaneous bits, quantization and motion information, one or more picture and macroblock types, weighted prediction information, or combinations thereof.

19. The networking system of claim 12, wherein the embedded global rate control bit allocation in the segments indicate a set of estimated quantization parameters for a plurality of frames in each of the segments and used as a guideline for video rate control by the video transcoders.

20. The networking system of claim 19, wherein using the global rate control bit allocation by the video transcoders for video rate control reduces fluctuation between the bit rates for the encoded segments and improves constant video quality.
